(19) United States
(12) Patent Application Publication
(10) Pub. No.: US 2010/0232401 A1
(43) Pub. Date: Sep. 16, 2010

(54) WIRELESS LOCAL AREA NETWORK SCAN BASED ON LOCATION

(75) Inventor: Olaf Hirsch, Sunnyvale, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/909,612

(22) PCT Filed: Mar. 23, 2006
(86) PCT No.: PCT/IB2006/050906

§ 371 Date: May 25, 2010

Related U.S. Application Data
(60) Provisional application No. 60/664,921, filed on Mar. 23, 2005.
(60) Provisional application No. 60/703,795, filed on Jul. 29, 2005.

(51) Int. Cl. H04W 84/12

(52) U.S. Cl. 370/338

(57) ABSTRACT

A system, apparatus and methods are described that define the frequency in which a scan for a wireless local area network access point (140) is performed. In one embodiment, a scan is performed when a change in the geographic location of a mobile wireless device (115) is identified.

This is a continuation of, and claims priority to, USPTO provisional application No. 60/664,921, filed Mar. 23, 2005.

The present invention relates generally to wireless communication technology, and more particularly, to scanning for a wireless local area network (“WLAN”) access point based on a geographic location of a wireless device.

The importance of wireless communication and its application to numerous different electronic devices is well understood. Wireless devices are continually being improved to include new features and functionality that enables a user to communicate, both voice and data, more effectively. One such feature, WLAN communication, is being integrated into a number of different wireless devices including cellular phones, smart phones and personal data assistants (“PDAs”).

Typically, a wireless device communicates with a WLAN via an access point on the network. A WLAN access point operates as a gateway on a network and allows the wireless device to communicate with other device on the network. This communication oftentimes requires the use of security features and certificates that aid in establishing a channel on which the wireless device and access point communicate. However, in order to establish a communication channel, the wireless device must first identify the existence of an active WLAN network. In an attempt to maintain WLAN access point availability, certain mobile wireless devices have an automatic detection feature that consistently scans for available WLAN access points with which the device may communicate. Thus, if a wireless device moves out of the range of a WLAN access point, the device may have identified a new WLAN access point or may continually scan for an available WLAN access point.

During the scanning process, the wireless device is searching for a signal from a WLAN access point. This signal may be a WLAN access point beacon or other communication that identifies a WLAN network to the wireless device. These WLAN access point signals may occur on many different channels or frequencies depending on the location of the access point, the WLAN communication protocol or other such factors. Accordingly, the scanning process requires that the wireless device search multiple channels on which WLAN communication may occur.

This consistent scanning process of multiple communication channels for WLAN access points may place a strain on a wireless device's processing resources and increase its power consumption. This strain on resources and power may reduce the lifespan of the wireless device power supply and overall performance of the device.

The present invention reduces the demand on the resources and power consumption of a mobile wireless device by controlling its scan for WLAN access points. The frequency of WLAN access point scans is reduced by using a change in the geographical location of the wireless device to trigger the scan. In one embodiment of the invention, a change in geographical location of the mobile wireless device is identified and, in response to this change, a scan for a WLAN access point is performed. The mobile wireless device may perform an active scan or passive scan.

In another embodiment of the invention, a change in geographical location of the mobile wireless device is identified. The mobile wireless device has a list of WLAN access points which are associated with various geographic locations. In response to a location change, the mobile wireless device attempts to identify a potential WLAN access point, from the WLAN access point list, corresponding to its new location. If a potential WLAN access point is identified, a scan is for a WLAN access point is initiated. This scan may be active or passive.

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

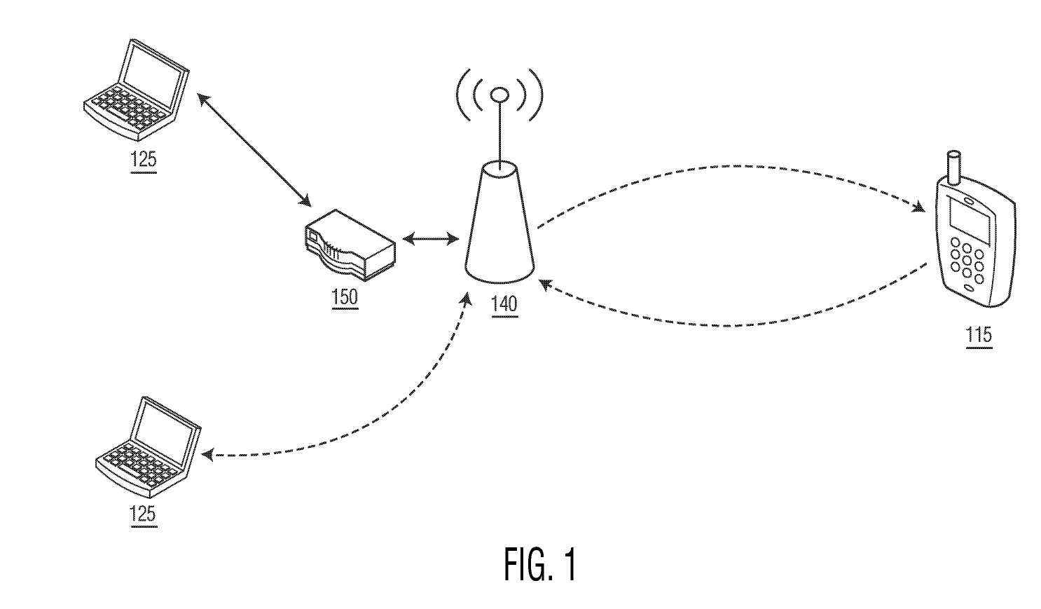

FIG. 1 is an illustration of a WLAN including an access point with which a wireless device may communicate according to one embodiment of the invention.

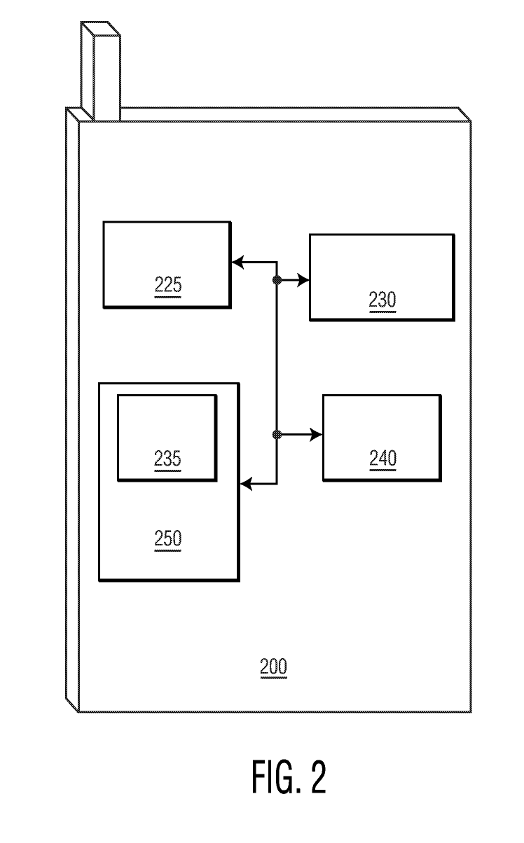

FIG. 2 is a block diagram of a wireless device according to one embodiment of the invention.

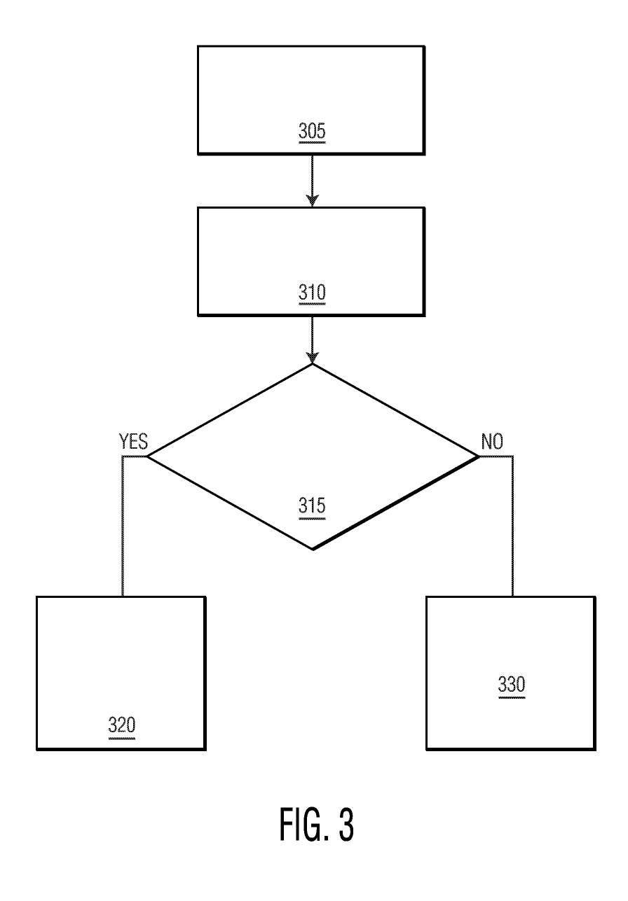

FIG. 3 is a flowchart describing a method of scanning for WLAN access points depending on a location of a wireless device according to one embodiment of the invention.

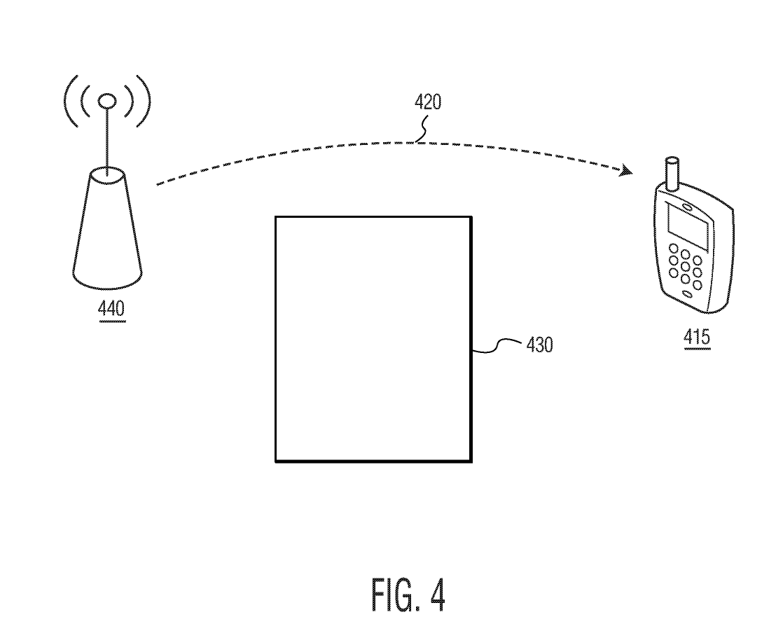

FIG. 4 is a diagram of a wireless device passive scan according to one embodiment of the invention.

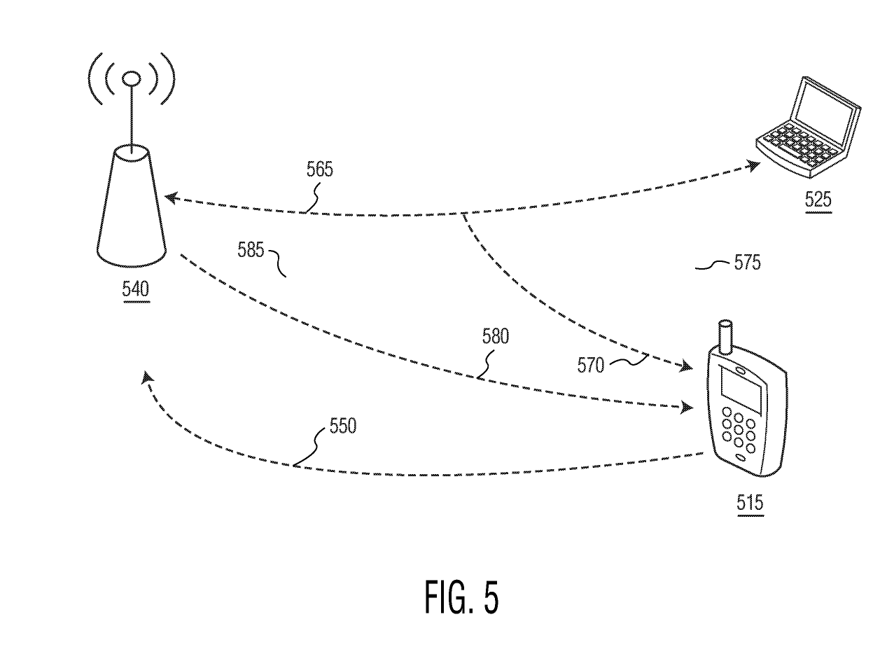

FIG. 5 is a block diagram of a wireless device active scan according to one embodiment of the invention.

A system, apparatus and method is described for providing a scan for WLAN access points that is initiated in response to a change in geographic location of a mobile wireless device. In one embodiment of the invention, the wireless device identifies its relative location and determines whether it has changed geographic locations. If such a location change has occurred, a WLAN scan is initiated. In another embodiment, the wireless device maintains a list of WLAN access points and associated geographic location(s) for each of the WLAN access points. In response to a mobile wireless device changing geographic locations, the new location is compared to the list of WLAN access points. The mobile wireless device may scan for WLAN access points if the comparison suggests that a WLAN access point should be available for the new location. These described embodiments are exemplary and one skilled in the art will recognize variations to and modifications of these embodiments are included within the present invention.

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be incorporated in a number of different wireless devices including cellular phones, smart phones and PDAs. The present invention may be integrated within these wireless devices as hardware, software or firmware. Accordingly, structures and devices shown below in block diagram are illustrative of specific embodiments of the invention and are meant to avoid obscuring the invention.

Reference in the specification to “one embodiment”, “another embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. System Overview

FIG. 1 illustrates a WLAN, having an access point with which a wireless device may communicate. The WLAN includes a wireless access point 140, a network switch or router 150, and a first network station 125 and a second network station 135. The WLAN may communicate with certain network stations on wired or wireless connections. Also, the wireless access point 140 and the network switch or router 150 may be integrated into the same box.

A mobile wireless device 115 may communicate with the WLAN access point 140 and operate within the WLAN itself. This communication requires an initial handshaking procedure in which the wireless access point 140 provides the mobile wireless device 115 certain parameters describing its communication protocol. Thereafter, a communication channel is created that allows data to be transmitted and received between the access point 140 and the mobile wireless device 115.

According to one embodiment of the invention, the mobile wireless device 115 does not consistently scan for WLAN access points. Rather, the mobile wireless device 115 scans after a change in its geographic location has been identified. This change in geographic location means that a mobile wireless device has moved a sufficient distance so that current communication with a current WLAN access point is unavailable.

The mobile wireless device 115 may identify its location using a number of different methods including a global positioning system feature, location information from a cellular tower/base station, or triangulation techniques using multiple cellular towers/base stations. After a change of location has been detected, the mobile wireless device 115 may initiate a scan for a WLAN access point. This triggering event, a change in location, allows the mobile wireless device 115 to avoid having to continually scan for access points.

In another embodiment, the mobile wireless device 115 may compare its new location to a list of known WLAN access points and corresponding geographic locations to determine whether a scan would be warranted. If one or more WLAN access points are identified that correspond to the new geographic location, a scan is initiated. This embodiment further reduces the number of scans that are performed by the mobile wireless device 115 and thereby reduces the demand on its processing resources and power consumption.

B. Wireless Mobile Device

FIG. 2 illustrates a mobile wireless device, including functional blocks, according to one embodiment of the invention. The mobile wireless device 200 includes an antenna interface 225, a geographic position locator 230, a WLAN scan module 240, and memory 250 that may include a WLAN access point directory 235. These components and modules may be integrated into a single component or multiple components within the device 200, and may be embodied in hardware, software or firmware.

The antenna interface 225 provides the various components and modules, within the mobile wireless device 200, access to information that is received by the device antenna and allows data to be transmitted from these components and modules onto communication channels. This information may be modified, re-formatted, or otherwise processed as it is communicated between the antenna interface 225 and the various components and modules within the mobile wireless device 200.

The geographic position locator 230 identifies a geographic location, either exact or approximate, of the mobile wireless device 200. In one embodiment, this geographic location may be identified by using a GPS feature that may be integrated in the device 200. The device 200 uses a triangulation method employing multiple GPS satellites that provides accurate information of the device 200 location. In another embodiment, the device 200 may use information about the location of a wireless cell in which it operates. This cell information may be derived from a cellular tower/base station and may be used to approximate the location of the device 200. One skilled in the art that other methods of identifying the device location may be used including triangulation of cellular towers to approximate the location of the device 200.

The WLAN scan module 240 initiates a scan for WLAN access points after the geographic position locator 230 identifies that the mobile wireless device 200 geographic location has changed. This scan may be a passive scan in which the device 200 is scanning for a WLAN access point beacon or an active scan in which the device actively seeks and requests a WLAN access point beacon.

According to another embodiment, the WLAN scan module 240 compares the new device location to a list of WLAN access points and corresponding geographic locations. This list may be maintained within the memory 250, in which the WLAN access point directory 235 contains multiple geographic locations and associated WLAN access points. This director 235 may be structured in numerous different ways in which geographic locations and WLAN access points are associated. After the comparison is performed, the WLAN scan module 240 initiates a scan only if the comparison suggests that a WLAN access point is present. This scan may be an active or passive scan.

FIG. 3 illustrates a method, independent of structure, of scanning for WLAN access points according to one embodiment of the invention. A mobile wireless device identifies 305 its geographic location. This identification may be done using various methods including the use of GPS functionality, association with a wireless cell or cellular tower, triangulation using multiple cellular towers, or other methods known within the art.

The mobile wireless device determines 310 whether it has changed geographic locations. This determination may be performed using various methods including comparing the identified geographic location with the previous geographic location of the device or determining when the device has moved outside of the range of a WLAN access point.

The mobile wireless device identifies 315 whether a WLAN access point should be present at the identified geographic location. This identification is performed without scanning for an access device and may be done internally or obtaining WLAN access point information from an external source. For example, the identified geographic location may be compared to an internal list of WLAN access points and corresponding locations to determine whether an access point should be available at the device's current identified geographic location.

In one embodiment of the invention, if there is not a WLAN access point identified by the device, prior to any scanning, the wireless device does not perform 330 a scan.

However, if a WLAN access point is identified, a scan 320 for the one or more identified WLAN access points is performed. This scan may include scanning multiple communication channels on which relevant WLAN information may be provided or obtained. Additionally, this scan may be an active scan or a passive scan.

a) Passive Scan

FIG. 4 illustrates an exemplary passive scan that may be performed in accordance with one embodiment of the invention. This passive scan may be initiated after a change in geographic location of a mobile wireless device 415 is identified. Furthermore, in another embodiment, this scan may be initiated only after potential WLAN access points are identified that correspond to the new geographic location of the device 415.

In one embodiment of the invention, the mobile wireless device 415 monitors various communication channels to identify a beacon from a WLAN access point 440. Depending on the geographic location, the number and specific frequencies of these channels may vary. For example, in the United States, the ISM band contains eleven channels on which WLAN communication may occur. Comparatively, the number of channels and their frequencies in other countries typically differ from those in the United States. Accordingly, the passive scanning requires that the mobile wireless device 415 be in a receive mode for each of the channels. The exact steps within the passive scan may be adapted to the location of the mobile wireless device 415.

The WLAN access point 440 usually transmits a beacon frame 430 in approximate 100 ms intervals on a particular channel 420. However, there may be instances where the beacon 430 is transmitted in shorter or longer intervals. The mobile wireless device 415 listens to the relevant channels to identify a beacon from the WLAN access point. This beacon frame 430 provides the mobile wireless device 415 with general network information, which allow the device 415 to communicate on the network. This beacon frame 430 may include the network service set identifier (“SSID”), network allocation vector (“NAV”) information, the supported rates of the network, transmission parameters (e.g., spread spectrum frequency hopping or direct sequence) of the network, station capability information, a traffic indication map (“TIM”) and other information relevant to the particular WLAN.

Once the mobile wireless device 415 has received and processed the beacon frame 430, it may communicate with the WLAN access point 440 and join the WLAN network itself.

b) Active Scan

FIG. 5 illustrates an exemplary active scan that may be performed in accordance with one embodiment of the invention. This active scan may be initiated after a change in geographic location of a mobile wireless device 515 is identified. Furthermore, in another embodiment, this scan may be initiated only after potential WLAN access points are identified that correspond to the new geographic location of the device 515.

In one embodiment of the invention, the mobile wireless device 515 updates its NAV so that it may communicate with a WLAN access point 540. This updating process may be done by intercepting communication 570 on a channel 565 between another wireless device 525 and the WLAN access point 540. The intercepted NAV information 575 allows the mobile wireless device 515 to update its own NAV so that it may transmit a probe request 550 frame to the WLAN access point 540.

After transmitting a probe, the mobile wireless device 515 waits for the WLAN access point 540 to respond to the probe. This response generally should occur within two beacon frame intervals. The mobile wireless device 515 must remain in receive mode during this waiting period to ensure that a response is detected and received. If no response is received, then the mobile wireless device 515 scans the next channel in a similar manner.

In response to a probe request frame, the WLAN access point 540 transmits a probe response 585 to the mobile wireless device 515. As described above, this probe response 585 includes information such as SSID and other information relating to the network. This probe response is processed by the mobile wireless device 515 so that the device 515 may communicate with the WLAN access point 540 and corresponding network.

The process of scanning for WLAN networks, using an active or passive scan, places significant demand on the resources of a mobile wireless device. In particular, this scanning process requires a relative large amount of power and may shorten the lifespan of the device's power supply. Accordingly, the ability to reduce the amount of scanning that is performed by the device may increase its overall performance and extend its power supply. The identification of a geographical location change of the device is used as a catalyst in initiating a WLAN scan. Furthermore, in one embodiment, a scan may only be triggered if a WLAN access point is identified that corresponds to the new geographic location of the wireless device.

While the present invention has been described with reference to certain embodiments, those skilled in the art will recognize that various modifications may be provided. Variations upon and modifications to the embodiments are provided for by the present invention, which is limited only by the following claims.

1. A scanning apparatus, located on a wireless device, for identifying a WLAN access point, the apparatus comprising: an antenna interface, coupled to receive and transmit information, to an antenna; a geographical locator, coupled to the antenna interlace, that identifies when the wireless device has changed its geographic location; and a WLAN scan module, coupled to the geographical locator, that causes the wireless device to initiate a scan for a WLAN access point in response to a change in the geographic location of the wireless device.

2. The scanning apparatus of claim 1 wherein the WLAN scan module initiates a passive scan for the WLAN access point.

3. The scanning apparatus of claim 1 wherein the WLAN scan module initiates an active scan for the WLAN access point.

4. The scanning apparatus of claim 1 further comprising: a WLAN access point directory, coupled to the WLAN scan module, that contains a plurality of stored WLAN access points associated with a plurality of stored geographic locations; and wherein the WLAN scan module initiates a scan for the WLAN access point if a stored WLAN access point, within the plurality of stored WLAN access points, is determined to corresponds to the changed geographic location of the wireless device.

5. The scanning apparatus of claim 4 wherein the WLAN scan module performs a passive scan.

6. The scanning apparatus of claim 4 wherein the WLAN scan module initiates a scan only in response to the change in the geographic location of the wireless device.

7. The scanning apparatus of claim 1 wherein the geographical locator uses GPS functionality to identify when the wireless device has changed its geographic location.

8. The scanning apparatus of claim 1 wherein the geographic locator uses information derived from a cellular tower to identify when the wireless device has changed its geographic location.

9. The scanning apparatus of claim 1 wherein a geographic location of a found access point, which may be used to establish a network, is stored in memory within the wireless device and is used to trigger a scan for the found access point during a subsequent use of the wireless device.

10. A method of scanning for a WLAN access point, the method comprising: identifying a geographical location of a mobile wireless device; determining whether the mobile wireless device has changed its location relative to a previous geographical location; and initiating a scan for the WLAN access point in response to a change in the geographical location of the mobile wireless device.

11. The method of claim 10 wherein the scan for the WLAN access point is performed passively by the mobile wireless device.

12. The method of claim 10 wherein the scan for the WLAN access point is performed actively by the mobile wireless device.

13. The method of claim 10 wherein the first geographical location of the mobile wireless device is identified using GPS.

14. The method of claim 10 wherein the scan for the WLAN access point is initiated only in response to the change in geographical location of the mobile wireless device.

15. A computer readable medium having instructions for performing the method of claim 10.

16. The method of claim 10 further comprising the step of storing a geographic location of a found access point, which may be used to establish a network, to trigger a scan for the found access point during a subsequent use of the wireless device.

17. A method of scanning for a WLAN access point, the method comprising: identifying a first geographical location of a mobile wireless device; determining whether the mobile wireless device has changed its location relative to a previous geographical location; identifying a potential WLAN access point corresponding to the first geographical location; and initiating a scan for the WLAN access point in response to the identified potential WLAN access point.

18. The method of claim 17 wherein the scan for the WLAN access point is initiated only in response to the identification of the potential WLAN access point corresponding to the first geographical location.

19. The method of claim 17 wherein the scan for the WLAN access point is done passively.

20. A computer readable medium having instructions for performing the method of claim 17.
